(19) United States
(12) Patent Application Publication
(10) Pub. No.: US 2014/0049975 A1
(43) Pub. Date: Feb. 20, 2014

(54) MODULAR MICRO-STRUCTURE LIGHT GUIDE DEVICE

(71) Applicants: Ching-Tsan LEE, Changhua County (TW); Chih-Bin Chiang, Changhua County (TW); Jih-Tao Hsu, Changhua County (TW); Wen-Liang Wang, Changhua County (TW)

(72) Inventors: Ching-Tsan LEE, Changhua County (TW); Chih-Bin Chiang, Changhua County (TW); Jih-Tao Hsu, Changhua County (TW); Wen-Liang Wang, Changhua County (TW)

(21) Appl. No.: 13/613,638

(22) Filed: Sep. 13, 2012

(30) Foreign Application Priority Data
Aug. 17, 2012 (TW) 101129873

(51) Int. Cl. F21V 8/00; F21V 7/00; F21V 5/04

(52) U.S. Cl. 362/511

(57) ABSTRACT

A modular micro-structure light-guide device, that composed of at least a micro-structure light guide unit. Each said micro-structure light guide unit comprises: a light source; a light coupling element, to transmit lights of said light source in parallel; and a light guide body, including at least two light incident surfaces, a micro-structure light uniformed region, a total reflection region, and a light exit surface. Wherein, said at least two light incident surfaces guide lights separately to said micro-structure light uniformed region and said total reflection region, and that reflects lights to exit from said light exit surface.

### BACKGROUND OF THE INVENTION

1. Field of the Invention

The present invention relates to a technology of light guide lamp, and in particular to a modular micro-structure light-guide device utilized in a vehicle lamp light guide system.

2. The Prior Arts

In general, while driving at night, due to the highly directional light-emission of LED light, the LED vehicle lamp appears to be formed by a plurality of separate and glaring light spots of similar visual effect without too much difference. However, along with the trend of putting emphasis on aesthetics of vehicle design, so that in designing a vehicle lamp, in addition to being able to provide illumination for safety and alarm, the manufacturers must also take into considerations that the visual effects it renders have to be able to catch the attention of the pedestrians. Therefore, the vehicle lamp light guide technology has progressed from emphasizing on the planar visual effect to 2D or even 2.5D visual effect. For the LED daylight lamps presently available on the market, it can be classified into a transmission type or a reflection type design. However, in order to achieve soft and even visual effect, the transmission type design is preferred.

Presently, most of the light guide device of the prior art utilizes a large-area light guide body or long light guide strip. The essence of this design is that, light guide elements are placed on two sides of light source, or a plurality of LEDs are arranged below the light guide strip, to achieve the visual effect of even and uniform illumination. Yet, for this kind of design, the technical requirements are rather high, and the enormous amount of light sources utilized could drive up the cost. In addition, since the structure and shape of the lamp fixture are designed by the manufacturers, therefore, the structure and shape of the light guide device had better be designed similarly by the manufactures to match with that of the lamp fixture, such that the variations of its applications are rather limited.

Therefore, presently, the design and performance of the light guide device is not quite satisfactory, and it has much room for improvements.

### SUMMARY OF THE INVENTION

In view of the problems and shortcomings of the prior art, the present invention provides a modular micro-structure light-guide device, that is capable of producing uniform light-emission visual effect, to overcome the deficiency and drawback of the prior art.

A major objective of the present invention is to provide a modular micro-structure light-guide device Wherein, two light incident surfaces placed in a light guide body are used to divide and separate the light path, to guide the light separately to a micro-structure light uniformed region and a total reflection region, so that the light exits from the light exit surface could produce visual effect of even and uniform luminous.

Another objective of the present invention is to provide a modular micro-structure light-guide device, that is capable of raising light utilization efficiency of the lamp, reducing number of light sources required. Also, a plurality of micro-structure light guide units can be arranged, without being limited by the shape of the light guide device and appearance of the lamp, to form patterns of various shapes, so as to increase variations of its designs and applications.

In order to achieve the above objective, the present invention provides a modular micro-structure light-guide device, comprising at least a micro-structure light guide unit. Each micro-structure light guide unit includes a light source, a light coupling element, and a light guide body. The light source and the light coupling element are placed on a side of the light guide body to provide the lights required by the lamp. The light guide body is composed of four parts: a light incident surface, a micro-structure light uniformed region, a total reflection region, and a light exit surface. Through adjusting the light path separation characteristics of the light incident surface, lights from the light sources can be distributed to the micro-structure light uniformed region and the total reflection region. Then, it utilizes a saw-tooth structure of the micro-structure light uniformed region and the angle of the total reflection region, in cooperation with a plurality of diffusion lenses of different curvatures on the light exit surface, to achieve the uniform luminous of the vehicle lamp.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a perspective view of a modular micro-structure light-guide device according to the present invention;

FIG. 2 is a mathematical model of a light coupling element in a modular micro-structure light-guide device according to the present invention;

FIG. 3 is a mathematical model of a light guide body in a modular micro-structure light-guide device according to the present invention;

FIG. 4 is a top view of a light exit surface of a micro-structure light guide unit according to the present invention; and

FIGS. 5A and 5B are two different embodiments respectively of a modular micro-structure light-guide device according to the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention relates to a modular micro-structure light-guide device, used to guide the lights of a vehicle lamp, to make the lights uniform and not glaring, hereby raising driving safety at night, and enabling the vehicle lamp to produce illumination effects of light pattern.

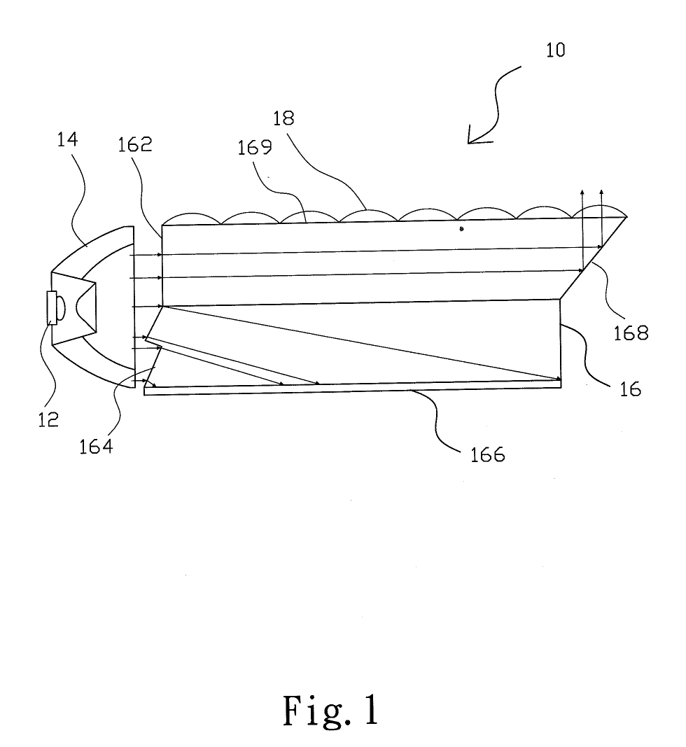

Refer to FIG. 1 for a perspective view of a modular micro-structure light-guide device according to the present invention. As shown in FIG. 1, the modular micro-structure light-guide device includes at least a micro-structure light guide unit 10, comprising: a light source 12, a light coupling element 14, and a light guide body 16. Wherein, the light source 12 and the light coupling element 14 are placed on a side of the light guide body 16, to provide lights required by the lamp, such that the light source 12 can be LEDs. The light guide body 16 includes the following four parts: two light incident surfaces 162, 164, a micro-structure light uniformed region 166, a total reflection region 168, and a light exit surface 169. The light coupling element 14 is used to transmit lights of light source 12 in parallel, while the first light incident surface 162 and the second light incident surface 164 divide and separate the lights into two light paths. Wherein, the first light incident surface 162 allows the lights to continue to go straight forward, to irradiate upon a total reflection region 168, and then exit from the light exit surface 169 after being reflected by the total reflection region 168. The total reflection region 168 is the main illumination region, the larger the area of this region, the brighter the illumination. On the other hand, the second incident surface 164 refracts the lights downward, and which includes slant surfaces of more than an angle, so as to diffuse the lights. Below the light guide body 16 is the micro-structure light uniformed region 166, that is provided with a saw-tooth surface on the side close to the light exit surface 169 to increase light reflection area, and to reflect the lights transmitting through the second light incident surface 164 and incident on the micro-structure light uniformed region 166, and then lights are exited from the light exit surface 169. Wherein, the surface of the side of micro-structure light uniformed region 166 close to the light exit surface 169 is of a saw-tooth shape. In addition, it can be of a circular net-spot shape, a prism shape, a cone shape, or a V slot shape surface structure.

On the outer surface of the light exit surface 169 is provided with a plurality of diffusion lenses 18, that can be column-shape lenses or sphere-shape lenses, or a combination of them. Each of the diffusion lenses 18 can be of a different curvature, so that the lights transmitted can be of different light patterns.

When light is emitted from the light source 12, it is transmitted through the light coupling element 14, to travel to the light guide body 16 in parallel. There, the first light incident surface 162 of the light guide body 16 guides the light to the total reflection region 168, then the light reflected by the total reflection region 168 is exited to outside through the light exit surface 169. On the other hand, light refracted by the second light incident surface 164 of the light guide body 16 travels through another light path, such that light is refracted downward to the micro-structure light uniformed region 166, to be reflected to the light exit surface 169 by the saw-tooth structure of the micro-structure light uniformed region 166. As such, the lights reflected by the total reflection region 168 and the micro-structure light uniformed region 166 are exited from the light exit surface 169. Then, it is diffused by the diffusion lens 18 into the light pattern required.

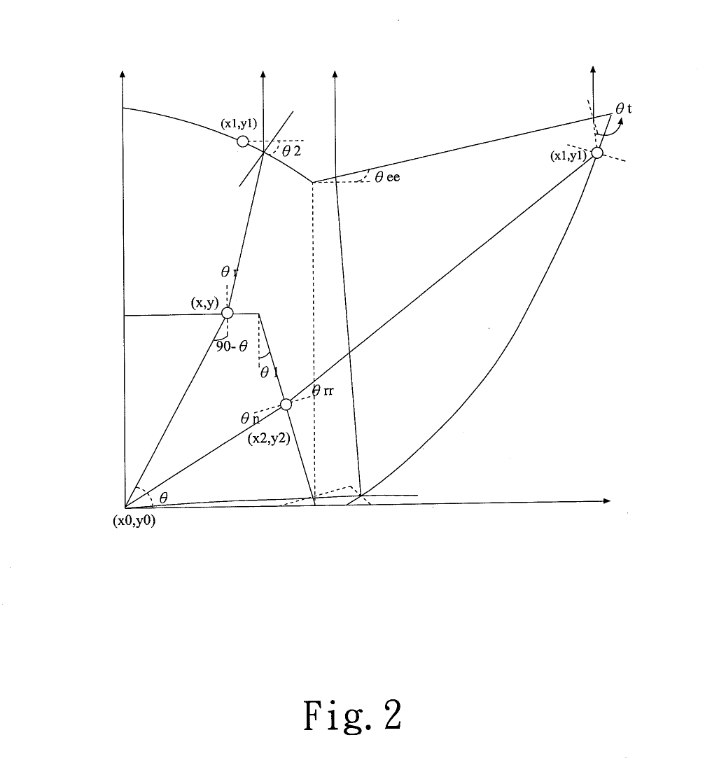

Next, refer to FIG. 2 for a mathematical model of a light coupling element in a modular micro-structure light-guide device according to the present invention. As shown in FIG. 2, the mathematical model of a light coupling element is set up through calculating angle and position of line sections. In the center of light coupling element is a plane-convex light gathering lens, its coordinate and angle can be obtained through the following equations:

$${θ}_{r} = {sin}^{- 1} ( sin ( 90 - θ ) / n ) ;$$

$${θ}_{2} = {tan}^{- 1} ( n \times sin ( {θ}_{r} ) / n \times cos ( {θ}_{r} ) - 1 )$$

$$y ( i + 1 ) = y ( i )$$

$$x ( i + 1 ) = ( y ( i + 1 ) - y 0 ) / tan ( θ )$$

$$x 1 ( i + 1 ) = \frac{( x ( i + 1 ) \times tan ( 90 - {θ}_{r} ) + x 1 ( i ) \times tan ( {θ}_{2} ) + y 1 ( i ) - y ( i + 1 )}{tan ( 90 - {θ}_{r } ) + tan ( {θ}_{2} ) }$$

$$y 1 ( i + 1 ) = ( x 1 ( i ) - x 1 ( i + 1 ) ) \times tan ( {θ}_{2} ) + y 1 ( i )$$

Moreover, the angle and coordinate of the light exit surface of the light coupling element can be calculated through the following equations:

$${θ}_{t} = {sin}^{- 1} ( sin ( {θ}_{ee} ) / n )$$

$${θ}_{n} = \vert θ - {θ}_{1} \vert$$

$${θ}_{rr} = {sin}^{- 1} ( sin ( {θ}_{n} ) / n )$$

$${θ}_{rl} = {θ}_{rr} + {θ}_{1}$$

$${θ}_{4} = ( {θ}_{t} - {θ}_{ee} + 90 + {θ}_{rl} ) / 2$$

$$x 2 ( i + 1 ) = \frac{x 2 ( i ) \times tan ( 90 - {θ}_{1} ) + x 0 \times tan ( θ ) + y 2 ( i ) - y 0}{tan ( θ ) + tan ( 90 - {θ}_{1} )}$$

$$y 2 ( i + 1 ) = ( x 2 ( i + 1 ) - x 0 ) \times tan ( θ ) + y 0$$

$$x 1 ( i + 1 ) = \frac{x 2 ( i + 1 ) \times tan ( {θ}_{r 1} ) - x 1 ( i ) \times tan ( {θ}_{4} ) + y 1 ( i ) - y 2 ( i + 1 )}{tan ( {θ}_{r 1} ) + tan ( {θ}_{4} )}$$

$$y 1 ( i + 1 ) = ( x 1 ( i + 1 ) - x 1 ( i ) ) \times tan ( {θ}_{4} ) + y 1 ( i )$$

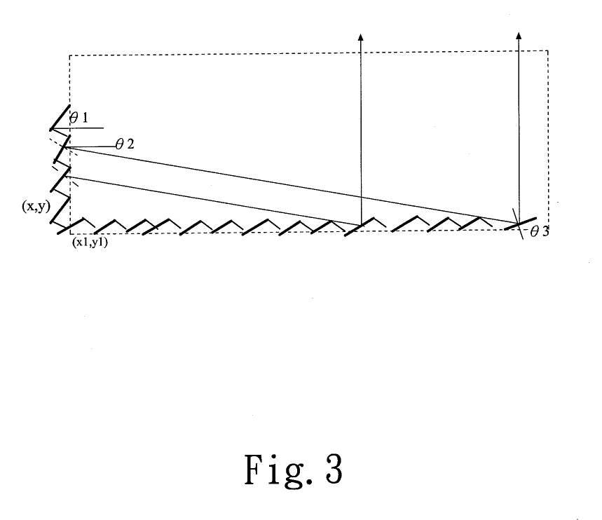

Then, refer to FIG. 3 for a mathematical model of a light guide body in a modular micro-structure light-guide device according to the present invention. As shown in FIG. 3, the mathematical model of a light guide body is obtained through calculating angles and positions of line sections. Wherein, for a light guide body, the characteristic relations for a light incident surface and a micro-structure light uniformed region can be obtained through the following equations:

$${θ}_{3} \geq {sin}^{- 1} ( \frac{1}{n} )$$

$${θ}_{2} = 90 - 2 \times {θ}_{3}$$

$${θ}_{1} = {tan}^{- 1} ( n \times sin ( {θ}_{2} ) / n \times cos ( {θ}_{2} ) - 1 )$$

$$y ( i + 1 ) = y ( i ) + Δ y$$

$$x ( i + 1 ) = ( Δ y ) / tan ( θ1 ) + x ( i )$$

$$x 1 ( i + 1 ) x 1 ( i ) + Δ x 1$$

$$y 1 ( i + 1 ) = ( x 1 ( i + 1 ) - x ( i + 1 ) ) \times tan ( {θ}_{2} ) + y ( i + 1 )$$

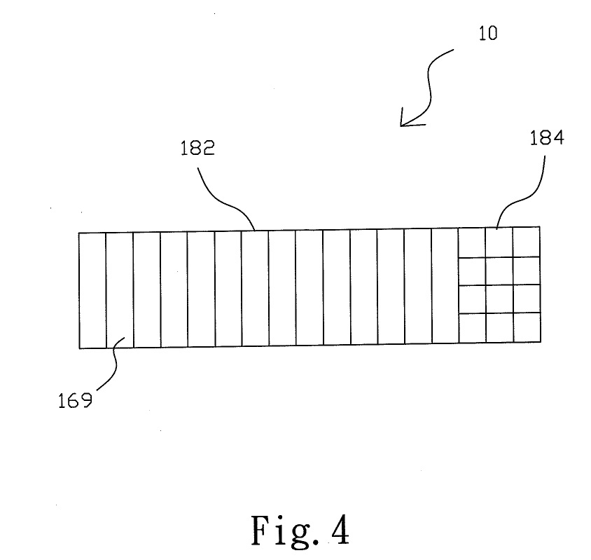

Subsequently, refer to FIG. 4 for a top view of a light exit surface of a micro-structure light guide unit according to the present invention. In this embodiment, the diffusion lens on top of the light exit surface can be seen clearly.

Wherein, on one side are the column-shape lenses 182, while on the other side are the sphere-shape lenses 184. Since the sphere-shape lenses 184 are located densely together, so in the vision of human eye, the shape of the emitted light on the left side appears to be a plurality of light columns, while on the right side is a piece of densely concentrated light, and the 12 light circles can not be discerned.

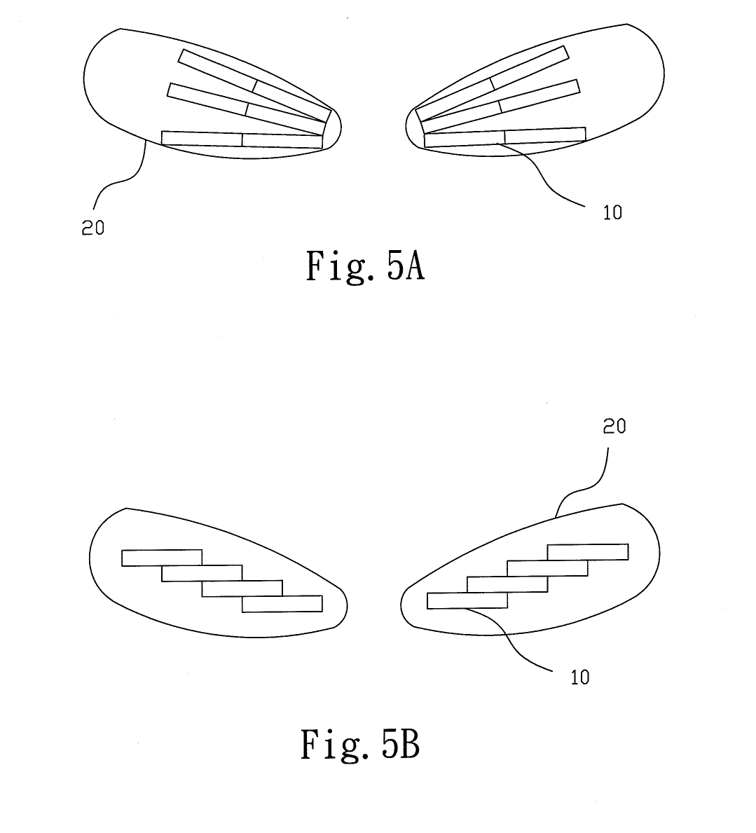

Finally, refer to FIGS. 5A and 5B for two different embodiments respectively of a modular micro-structure light-guide device according to the present invention. In FIG. 5A, for a vehicle lamp 20, six micro-structure light guide units 10 are provided. Wherein, each two micro-structure light guide units 10 are put into a long strip, and that is arranged in a diffusion way to form light emission patterns, so that the illumination is most intense in the adjoining portion of two vehicle lamps 20. In FIG. 5B, for a vehicle lamp 20, four micro-structure light guide units 10 are provided. Wherein, four micro-structure light guide units 10 are arranged into a step shape, to form a light guide device having special light emission patterns. Therefore, the micro-structure light guide units 10 can be arranged based on the design concept and actual requirement, to produce various light emission patterns.

In addition, the modular micro-structure light-guide device can be designed through varying the curvatures of the diffusion lenses and colors of LEDs, such as red, yellow, amber, and white, such that lamps of various applications can be produced. For example, tail light, back-up light, direction light, side direction light, road sign, and indoor reading light.

Summing up the above, in the modular micro-structure light-guide device of the present invention, a unique light guide body is used, such that light sources are placed on a side of the light guide body. Through adjusting the light incident surface of the light guide body to separate the light path, light is guided to the micro-structure light uniformed region and the total reflection region. The saw-tooth structure on the micro-structure light uniformed region could scatter the light more evenly, and the total reflection region is the main illumination region, to provide visual effect of uniform light emission, while reducing number of light sources required. A plurality of micro-structure light guide units can be arranged into patterns of various shapes without being limited by the shape and appearance of the lamp. The curvature of the diffusion lens and colors of LED can be varied based on actual requirements of various lamps, to increase variations of its designs and applications significantly.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A modular micro-structure light-guide device, composed of at least a micro-structure light guide unit, each said micro-structure light guide unit comprises:
a light source;
a light coupling element, to transmit lights of said light source in parallel;
a light guide body, including at least two light incident surfaces, a micro-structure light uniformed region, a total reflection region, and a light exit surface, wherein, said at least two light incident surfaces guide lights separately to said micro-structure light uniformed region and said total reflection region, and that reflect lights to exit from said light exit surface.

2. The modular micro-structure light-guide device as claimed in claim 1, wherein on said light exit surface is further provided with a plurality of diffusion lenses.

3. The modular micro-structure light-guide device as claimed in claim 2, wherein said diffusion lenses each having different curvature.

4. The modular micro-structure light-guide device as claimed in claim 2, wherein said diffusion lenses is at least a column-shape lens or at least a sphere-shape lens, or a combination of them.

5. The modular micro-structure light-guide device as claimed in claim 1, wherein a side of said micro-structure light uniformed region close to said light exit surface is of a saw-tooth shape, a circular net-spot-shape, a prism shape, a cone shape, or a V slot shape surface structure.

6. The modular micro-structure light-guide device as claimed in claim 1, wherein slopes of said at least two light incident surfaces are different.

7. The modular micro-structure light-guide device as claimed in claim 1, wherein said at least a micro-structure light guide unit is arranged into various light emission patterns.
